(19) United States
(12) Patent Application Publication
(10) Pub. No.: US 2022/0354298 A1
(43) Pub. Date: Nov. 10, 2022

(54) COOLING DEVICE FOR STORAGE CONTAINERS HAVING LIQUID FOODSTUFFS

(71) Applicant: Franke Kaffeemaschinen AG, Aarburg (CH)

(72) Inventor: Stefan Remo WENIGER, Muhen (CH)

(73) Assignee: Franke Kaffeemaschinen AG, Aarburg (CH)

(21) Appl. No.: 17/769,801

(22) PCT Filed: Oct. 9, 2020
(86) PCT No.: PCT/EP2020/078468

§ 371 Date: Apr. 18, 2022

(30) Foreign Application Priority Data
Oct. 17, 2019 (DE) 10 2019 128 126.1

(51) Int. Cl. A47J 31/41; A47J 31/44; A47J 31/46; A47J 31/60

(52) U.S. Cl. CPC A47J 31/41; A47J 31/4485; A47J 31/468; A47J 31/60

(57) ABSTRACT

In a cooling device (10) having a coolable storage chamber (15) for storing a plurality of storage containers (11, 12, 13, 14) having liquid foodstuffs to be made available for dispensing to a beverage dispensing device connected to the cooling device, two or more receiving compartments (21, 22, 23, 24) are provided, each of which receives one pump module (30, 30′, 30a, 30a′, 30a″, 30a′″) which is used to pump liquid foodstuff of a foodstuff type allocated to the relevant pump module to a beverage dispensing device connected to the cooling device.

### TECHNICAL FIELD

The invention relates to a cooling device for storing a plurality of storage containers having liquid foodstuffs which are intended to be supplied to a beverage-dispensing device, which is connected to the cooling device, for dispensing purposes.

### BACKGROUND

In the case of beverage-dispensing machines for dispensing hot and cold beverages, liquid foodstuffs which have to be stored in cooled form are frequently dispensed or added. This is in particular in the case of fully automatic coffee machines which, in addition to freshly brewed coffee beverages, also dispense milk or milk-containing beverages. For example, in the case of a cappuccino or latte macchiato, frothed milk is added to the freshly brewed coffee. The milk has to be stored in this case in a cooling chamber so that the milk does not spoil.

In the case of fully automatic coffee machines for use in the catering sector, it is known to store the milk in a separate cooling unit configured in the form of a supply device. Such a supply device for two or more storage containers is shown by way of example in WO 2017 137204 A1. Two fully automatic coffee machines can be connected to the device. For this purpose, in the supply device are installed two milk pumps with which milk can be conveyed from in each case one of the storage containers to the respectively connected fully automatic coffee machine.

### SUMMARY

The object of the present invention is to make a cooling device of the type mentioned at the beginning usable more flexibly and to extend the diversity of beverages that can be supplied via such a device.

The object is achieved by a cooling device having one or more of the features disclosed herein. Advantageous refinements can be gathered from the description and claims that follow. Furthermore, an arrangement having such a cooling device and a cleaning device which is connected to the latter is specified.

The cooling device according to the invention has a coolable storage chamber for storing a plurality of storage containers having liquid foodstuffs and two or more receiving compartments for receiving one pump module each for conveying liquid foodstuff of a foodstuff type, which is respectively assigned to the relevant pump module, to the beverage-dispensing device connected to the cooling device. A modular design of the pump modules which can be inserted into receiving compartments correspondingly configured for this purpose is therefore essential. It is also essential for the pump modules which can be installed and operated in the cooling device to each be assigned to only one foodstuff type. Therefore, pump modules for different foodstuff types can be flexibly combined and operated in the cooling device. A pump module is prevented from coming into contact with different foodstuff types since this could lead to an adverse effect on taste. Foodstuff types which can be stored and provided may include, inter alia, milk and cold brew, cooled coffee.

The receiving compartments of the cooling device are preferably designed in such a manner that they have, on a front side, an opening for inserting a pump module and, on a side facing away from the opening, one or more hydraulic and/or electrical plug-in connections via which, in each case with counterparts arranged and correspondingly positioned on a rear side of the inserted pump module, a hydraulic and/or electrical connection of the inserted pump module to the cooling device is formed. The pump modules can therefore be simply inserted from the front into the receiving compartment, and the pump module is automatically connected by corresponding electrical and/or hydraulic plug-in connections on the pump module and receiving compartment being connected. The hydraulic plug-in connections preferably have a rapid closure such that the respective connections are closed when a pump module is removed.

In a preferred refinement of the cooling device, a rack frame having insertion compartments for the pump modules is arranged inside the coolable storage chamber, and the pump modules are configured in the form of insertion modules. This permits a particularly simple installation and a rapid and easy upgrading of the cooling device with further or alternative pump modules. Accommodating the pump modules in the cooled region prevents food residues that may have remained in the pump and lines between individual product-dispensing operations from spoiling, and extends the cycles in which automatic cleaning of the pump modules is to be carried out.

In particular, it is provided, within the scope of the present invention, that the front side of each of the pump modules has at least one first connection, which is designed as a product connection, for a flexible connecting line which is connectable to an associated storage container. The product connection for the foodstuff to be conveyed is therefore located on the front side of the pump module, which side is accessible for the user, and therefore the pump module can be connected very simply to a storage container stored in the storage chamber.

In a development of the invention, the front side of each of the pump modules also has at least one second connection which is configured in the form of a cleaning connection and with which the flexible intake line belonging to the respective pump module can be connected, rather than to a storage container, in order to form a loop. This cleaning connection is guided here to the rear side of the pump module and is connected there to a cleaning liquid feed line. In this way, by the intake line being removed from the storage container and connected to the second connection, a cleaning operation of the relevant pump module can be carried out, with the intake line being cleaned at the same time.

Furthermore, the front side of at least one of the pump modules can be provided with two product connections for intake lines, which are connectable to separate storage containers, and two cleaning connections, wherein the cleaning connections are connected in parallel inside the pump module and the two product connections are selectively connectable to a pump of the pump module via a valve arrangement. This permits a controlled switching-over from one storage container to the other, even during the period of preparation of a product. The product preparation therefore does not need to be interrupted if one of the storage containers is empty. Instead, an empty signal can be issued to the operator to exchange the empty container. This may be advantageous particularly in the self-service sector since, after an empty signal for the first connected storage container, the product-dispensing operation continues to be ensured via the second connected storage container and there is sufficient time for exchanging or filling the container up without the beverage-dispensing device having to be taken out of operation or a relevant product-dispensing operation at the device having to be blocked.

The cleaning liquid feed line is preferably guided here via a hydraulic plug-in connection located on the rear side of the respective pump module to a cleaning device which is connected to the cooling device and which supplies the respective pump module with cleaning liquid in order to carry out a cleaning operation. A hydraulic plug-in connection on the rear side of the pump module permits simple removal or installation of the pump module. Via a cleaning device connected externally to the cooling device, an operationally reliable and hygienic cleaning of all of the pump modules can be ensured, wherein the foodstuff region of the cooling device remains spatially separated from the cleaning device such that an inadvertent contamination of foodstuffs with cleaning liquid is ruled out.

Within the scope of the present invention, it can also be provided that the rear side of each of the pump modules has at least one hydraulic plug-in connection with a quick closure, which, in each case with a counterpart arranged and correspondingly positioned on the rear side of the receiving compartments, forms a hydraulic connection to in each case one beverage line placed inside the cooling device for the respective liquid foodstuff to be conveyed. Such a plug-in connection with a quick closure permits simple removal and installation of the pump modules. Via the beverage lines placed inside the cooling device, the pump modules are connected to the connected beverage-dispensing device(s) during the installation of the cooling device.

In a particularly preferred embodiment, each of the modules has a code which can be read via the cooling device and which specifies the foodstuff type assigned to the pump module. Such a code can be provided, for example, in the form of an RFID chip or an optically readable barcode or block code. The cooling device is designed here to announce the foodstuff type read by the respective pump module to the connected beverage-dispensing device. The effect achieved by this is that the controller of the beverage-dispensing device obtains the information as to which pump modules are installed in the connected cooling device and which types of foodstuff are therefore available for dispensing a beverage or for adding. Furthermore, it is advantageous if the cooling device additionally announces the respectively current operating state of the pump modules to the connected beverage-dispensing device, for example whether a foodstuff is empty and the relevant storage container has to be exchanged, or whether there is a malfunction at one of the pump modules.

An example of one type of beverage can be milk. After the controller of a connected beverage-dispensing device obtains the information that a pump module for milk has been connected, milk or milk-containing beverages and beverages with milk froth can be provided and dispensed via the beverage-dispensing device. A further foodstuff type could be cold brew coffee. If the controller of a connected beverage-dispensing device obtains the information that there is a pump module for cold brew coffee, the latter can be provided and dispensed as an additional beverage variant at the beverage-dispensing device. A recognition of the available beverage types on the basis of a code of the pump modules thus permits a simple plug-and-play operation.

The pump modules each comprise a pump for the medium assigned thereto. In a preferred embodiment, at least one of the pump modules has, in addition to a pump, a gas feed line opening on the suction side of the pump into the pump feed line and a counterpressure element which is arranged downstream of the pump in the conveying direction and via which fluid sucked up by the pump is conveyed in the direction of the beverage-dispensing device connected to the cooling device. Via the gas feed line, gas is additionally sucked up by the pump such that a foodstuff and gas mixture is produced. The counterpressure element leads to an increase in pressure in the pump. By this means, a froth is produced from the foodstuff/gas mixture in the pump. This can be used, for example, for dispensing milk froth. It is also possible to froth other beverage types, such as cold brew coffee, with a gas. For example, (ambient) air or nitrogen can be used as the gas.

Either a constriction, i.e. a narrowed cross section and subsequent widened section such as, for example, an orifice plate or restrictor, can be used as the counterpressure element. The counterpressure element may also be formed by a simple pressure hose with a reduced internal cross section. However, the use of a mixer, in particular a static spiral mixer, which does not have a narrowed cross section but acts as a flow resistor by changing the direction multiple times, is preferred within the scope of the invention. Such a mixer moreover causes the stream of liquid enriched with gas to be split up and merged many times in multiple partial streams such that further mixing and enhancement of the creamy foodstuff/gas mixture is obtained. A further form of a flow resistor suitable within the scope of the invention is what is referred to as a resistance passage element which is formed by a multiplicity of flow paths branching out in a labyrinth-like fashion and likewise causes the stream of fluid to be split up many times into partial streams, merged and split up again.

A geared pump, in particular, can be considered as the pump. It has been proved that this type of pump yields the best deliciously creamy and frothy consistency. This may be due to particularly thorough mixing of the foodstuff/gas mixture by the gearwheels of the pump.

In a further preferred embodiment, the supplied amount of gas can be metered by a gas-metering valve. A simple valve needle, by means of which the amount of air can be metered by adjusting the suction opening, can be used, for example, as the gas-metering valve. However, a timed closing valve, possibly combined with a fixed orifice plate and which opens and closes in quick succession and hence frees and recloses the suction opening, is preferably used within the scope of the present invention. In this case, the duty cycle, i.e. the ratio between the time open and the repetition interval, can be modified for the purpose of the metering. The gas-metering valve is thus opened on average for a shorter or longer duration in order to add in less or more gas, respectively. The consistency of the dispensed beverage can in particular also be modified via the amount of gas.

If, instead of normal ambient air, a gas from a gas pressure store, for example nitrogen, is to be added to one or more foodstuff types, a high-pressure connection for connecting a gas pressure vessel which is arranged outside the cooling device and in which the gas is stored under pressure can be provided on the cooling device. In this case, a pressure-relief device which is designed to reduce the pressure of the gas to a pressure close to the ambient pressure, in particular to less than 0.5 bar, furthermore preferably to less than 100 mbar, most preferably to less than 50 mbar above the ambient pressure, is located on the high-pressure connection. Via this pressure-relief device, the high-pressure connection is connected to the gas feed line opening into the intake line, in order to supply the gas at a reduced pressure to the sucked-up beverage on the suction side of the pump.

In a further advantageous development of the present invention, the cooling device is provided with an interface circuit which is designed for connecting a controller which is assigned to the external beverage-dispensing device. The pump modules can be activated via the interface circuit such that the dispensing of liquid foodstuffs can be controlled by the controller of the beverage-dispensing device.

Furthermore, the present invention relates to an arrangement consisting of a cooling device of the type described above and a cleaning device which is connected to the cooling device and which supplies the individual pump modules of the cooling device with cleaning liquid via separate cleaning liquid feed lines connected to a connection array of the cooling device if a respective cleaning operation is intended to be carried out. By means of the external arrangement of a cleaning device, the foodstuff storage remains spatially separate from the storing and processing of the cleaning chemicals. The individual pump modules can be cleaned individually, independently of one another, or all at the same time.

The function of the cleaning device resides in providing the required cleaning liquid when a cleaning operation is to be carried out. In a preferred embodiment, the cleaning device has a cleaning agent storage container with cleaner concentrate, and a mixing container for mixing the cleaning liquid consisting of cleaner concentrate and water. For this purpose, the mixing container can be connected to a water inlet via a shut-off valve. The metering pump conveys cleaner concentrate out of the cleaning agent storage container into the mixing container. Via a plurality of outlet valves connected to the mixing container, various outlet connections which are connected to the cleaning liquid feed lines of the cooling device can be activated separately.

The cleaning device preferably has at least one flow meter for determining the quantity of cleaner concentrate and/or water conveyed into the mixing container. Furthermore, it is advantageous if the water inlet and the metering pump are connectable in a switchable manner via switching means to a feed line to the mixing container, in which feed line the flow meter is situated. The latter can therefore serve both for metering the cleaner concentrate and the quantity of water. Furthermore, a second flow meter can be provided in the outlet line of the mixing container and can be used to determine the quantity of cleaning agent solution output per cleaning cycle.

### BRIEF DESCRIPTION OF THE DRAWINGS

Further advantages and properties of the invention emerge from the description below of an exemplary embodiment with reference to the figures, in which

FIG. 1 shows a view of a cooling device having foodstuff containers and pump modules,

FIG. 2 shows a rack frame which is installed in the cooling device of FIG. 1 and has a total of four insertion compartments for pump modules,

FIG. 3 shows a pump module used in the cooling device of FIG. 1,

FIG. 4 shows a water flow diagram of a cooling device with four pump modules, and

FIG. 5A shows an enlarged detail of a pump module from FIG. 4 with a media connection,

FIG. 5B shows an alternative pump module with two media connections, and

FIG. 6 shows an enlarged detail of the cleaning device from FIG. 4.

### DETAILED DESCRIPTION

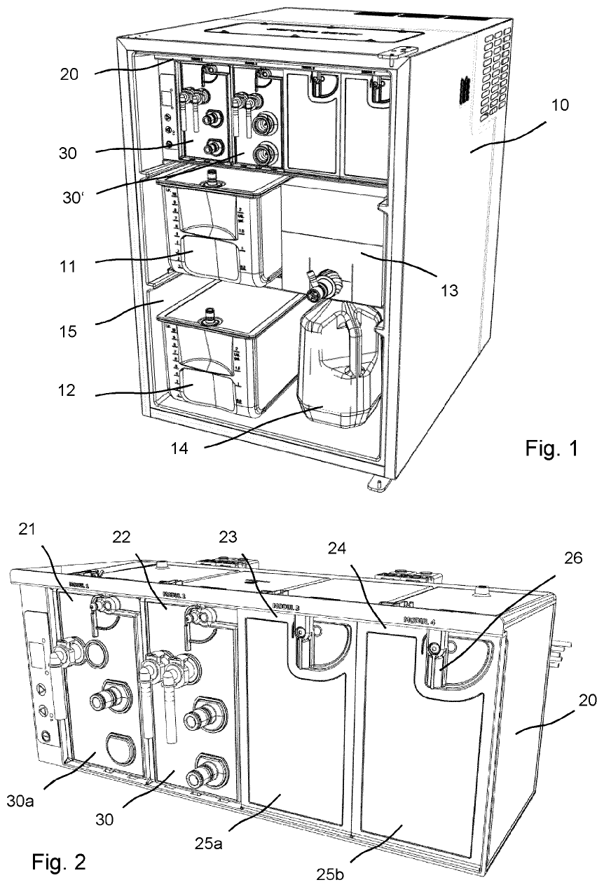

FIG. 1 shows by way of example a cooling device 10 which is configured in the form of a refrigerator and has a cooled storage chamber 15 and four storage containers 11, 12, 13, 14, which are stored therein, for liquid foodstuffs. The containers 11, 12 are transparent plastics containers which are closed with covers and which can be filled with liquids. The container 13 is a disposable container in the manner of a bag-in-box package, i.e. a tubular container held in a carton. By way of example, a type of plastics canister (“gallon”) is shown as the container 14. Of course, various types of container may be combined as desired, for example all of the containers may be designed as bag-in-box containers or as finable plastics containers.

A rack frame 20 is installed in the upper region of the refrigerator 10. In FIG. 1, two pump modules 30, 30′ are inserted in receiving compartments in the rack frame, two further receiving compartments are unoccupied and are closed by blank panels. In principle, the pump modules 30, 30′ can be constructed identically. However, it is not ruled out that the pump modules differ in their design depending on the type of respectively provided foodstuff. For example, it can be seen in FIG. 1 that the pump modules 30, 30′ have different front-side connections.

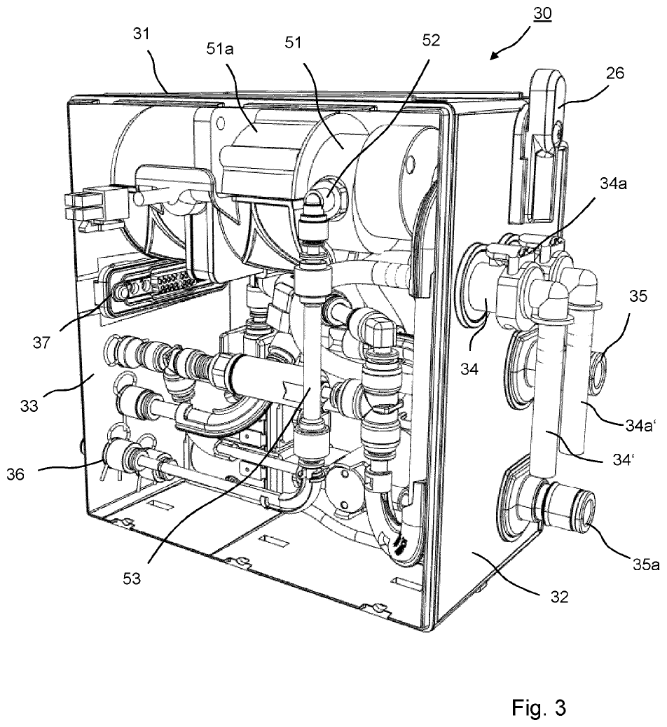

The rack frame is illustrated in more detail in FIG. 2, with, in turn, different pump modules 30, 30a being used. The rack frame 20 has a total of four insertion compartments 21, 22, 23, 24 which serve as receiving compartments for receiving the pump modules. A respective pump module 30, 30a is inserted into the insertion compartments 21 and 22. The insertion compartments 23 and 24 are left empty and closed by a panel 25a, 25b, but may also be occupied with a pump module at any time if required. The pump modules 30, 30a, which are configured in the form of insertion modules, and the panels 25a, 25b are each provided with a latch 26 with which the pump modules 30, 30a and panels 25a, 25b are locked in the rack frame 20. An actually present front door of the refrigerator 10 has been omitted in FIG. 1 for better clarity.

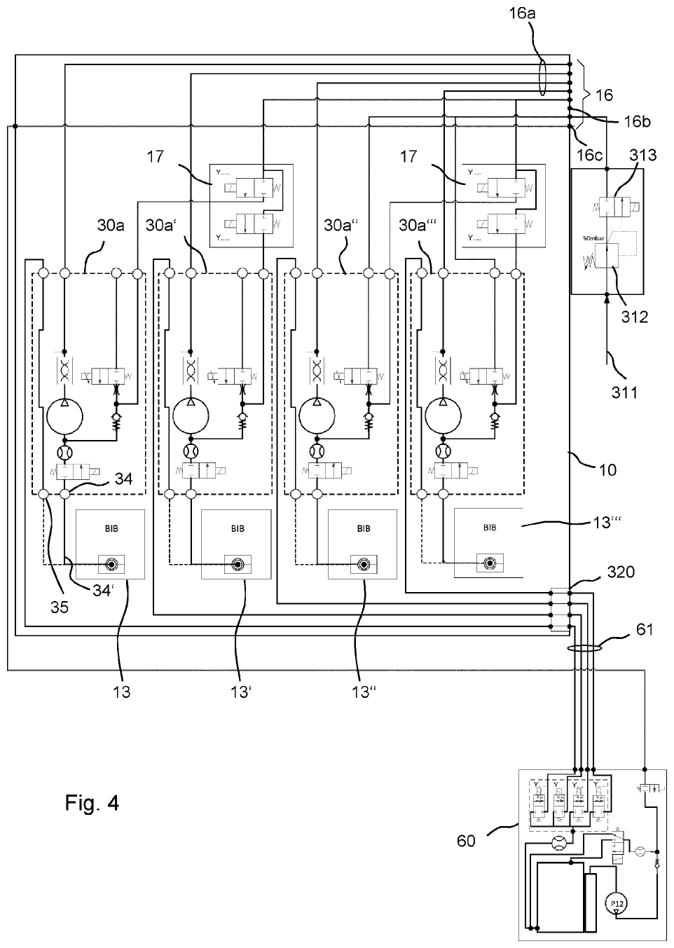

The pump module 30 is illustrated in more detail in FIG. 3. The pump module 30 which is configured in the form of an insertion module has a housing 31 with a housing front side 32 and a rear wall 33. Located on the front side 32 and arranged next to each other are two product connections 34, 34a to which an intake hose 34′, 34a′ is in each case connected via a corresponding hose connector. Said intake hoses have been cut away here for clarity reasons, but actually lead to in each case one of the storage containers 11-14 accommodated in the refrigerator. In addition, on the front side 32 are situated two cleaning connections 35 which are arranged one above the other and onto which in each case the remote end, not illustrated here, of the intake hose 34′, 34a′ can be plugged or screwed when required in order to carry out cleaning. The precise function of the cleaning connections 35, 35a is explained in more detail below.

An electrical plug-in connection 37 and a hydraulic plug-in connection 36 are arranged on the rear wall 33 of the pump module 30. The liquid foodstuff conveyed by the pump module 30 is provided via the hydraulic plug-in connection 36. Via correspondingly positioned counterparts on the rear side of the rack frame 20, the pump module 30 is electrically and hydraulically connected inside the refrigerator 10.

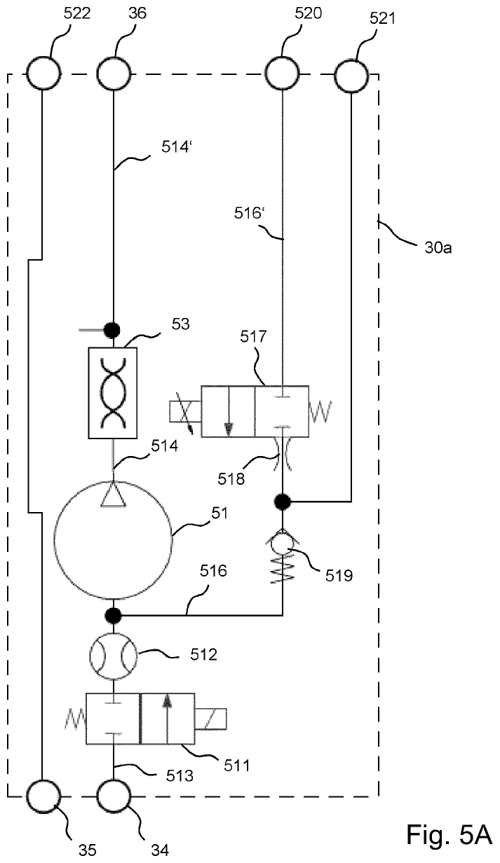

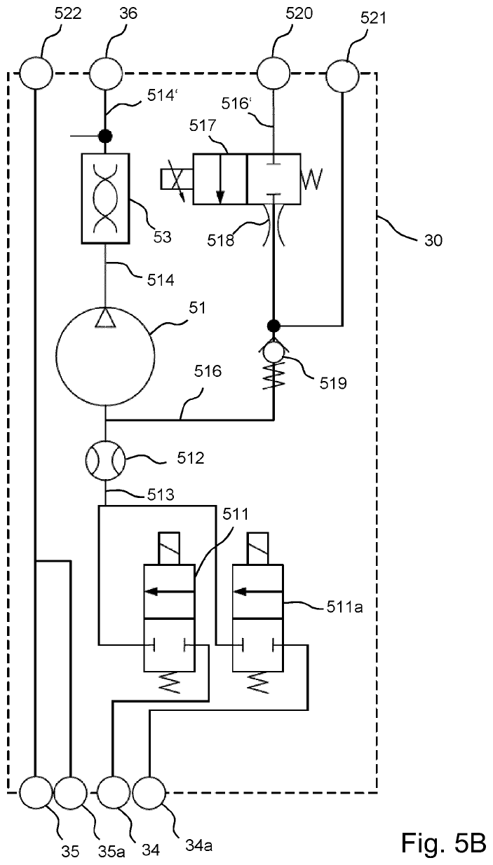

In the illustration of FIG. 3, a side wall of the housing 31 of the pump module 30 has been removed and opens up a view into the interior of the pump module 30. A pump 51 with a pump motor 51a can be seen in the upper region. The intake side of the pump 51 is connected to the front-side connections 34. A static mixer 53, what is referred to as a spiral mixer, serving as a pressure-increasing element is situated at the outlet connection 52 of the pump 51. The further components of the pump module are shown only schematically in FIG. 3. The precise design and the hydraulic connection of the components inside the pump modules will be explained in more detail below with reference to FIGS. 4, 5A and 5B.

While the pump module 30, as explained, has two product connections 34, 34a having an intake hose 34′, 34a′ leading in each case to a storage container 13, in the case of the second pump module 30a inserted into the rack frame in FIG. 2 in each case only one product connection 34 and one cleaning connection 35 can be seen.

As shown in FIG. 2, either pump modules 30 having two product connections or pump modules 30a having only one product connection can be used, with the modules concerned also being able to be mixed. While, in the case of pump modules 30a of the type having only one product connection, only one storage container can therefore be connected, accordingly two storage containers can be connected to pump modules 30 of the type having two product connections. In this case, if one of the connected storage containers is empty, a switch can be made to the other via switchover valves inside the pump module 30. Correspondingly, two cleaning connections 35, 35a can likewise be seen on the front side of the pump module 30, onto which cleaning connections the intake hoses 34′, 34a′ can be plugged in order to carry out cleaning.

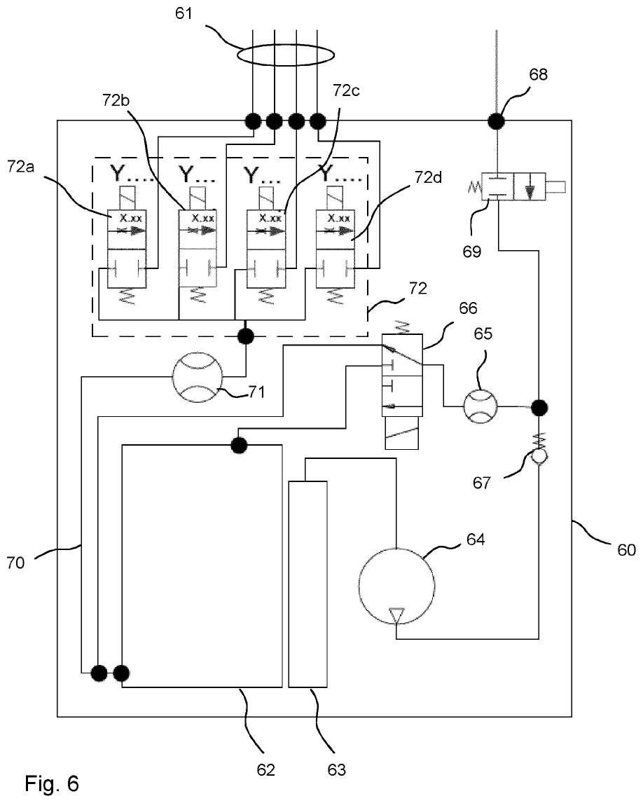

FIG. 4 shows the design and the hydraulic circuitry of the pump modules inside the cooling device 10 in the form of what is referred to as a water flow diagram. In this case, in the cooling device 10, a total of four identically designed pump modules 30a, 30a′, 30a″, 30a′″ each having only one product connection 34 are installed. On the suction side, each of the pump modules is connected to a storage container 13, 13′, 13″, 13′″ which is configured in each case as a disposable container in the form of a bag-in-box packaging. The relevant intake line 34′ is connected to the front-side connection 34 of the respective pump module 30a, 30a′, 30a″, 30a′″. The intake line 34′ can be removed from the respective storage container 13 if required and instead connected to the second front-side connection 35 if namely a cleaning operation is to be carried out. This is indicated by a dashed line. A cleaning device 60 which is connected to the cooling device 10 via corresponding supply lines 61 and the design and function of which will be explained in more detail further below with reference to FIG. 6 is used for the cleaning.

In the upper region of the cooling device there are various hydraulic connections 16 via which up to two external fully automatic coffee machines can be connected to the cooling device 10. The connections 16 firstly comprise hydraulic connections for the foodstuff lines 16a coming from the pump modules 30a, 30a′, 30a″, 30a′″, and next to them a connection for cold water 16b which is used in the manner to be explained below for flushing the pump modules 30a, 30a′, 30a″, 30a′″ with cold water, and a hot water connection 16c which is looped through to the cleaning device 60 and via which hot water is provided by the hot water provider of a connected fully automatic coffee machine for cleaning operations.

The pump module 30a which is enlarged in the form of a detail in FIG. 5A comprises an electric pump 51 which is connected on the intake side via an intake line 511 to the connection 34. In the intake line 511, between the connection 34 and the pump 51, there is a flow meter 512 with which the sucked-up quantity of fluid can be determined, and a closing valve 513 which is opened at the beginning of a product-dispensing operation and is closed after the end of the product-dispensing operation, in order to prevent fluid from flowing back to the connection 34.

The spiral mixer 53 which serves as a counterpressure element is connected to the delivery side of the pump 51 via an outlet line 514. The outlet line 514′ leads from said spiral mixer to the rear-side plug-in connection 36.

In addition, a gas supply line 516 opens into the intake line 511 between the flow meter 512 and the pump 51. A gas-metering valve 517, a fixed orifice plate 518 and a nonreturn valve 519 are located in the gas supply line 516. In the exemplary embodiment, the gas-metering valve 517 is designed as a timed air valve, i.e. as a switching valve operated in a rapid sequence, intermittently opening and closing. The frequency at which the air valve 517 is operated can be within the range of between approximately 10 and 30 Hz here. The nonreturn valve 519 serves merely to prevent liquid from penetrating the air supply line 516.

From the air valve 517, the air supply line 516′ leads to a pneumatic plug-in connection on the rear wall 33 of the pump module 30. Via said plug-in connection, a gas, for example nitrogen, can be supplied. For this purpose, a high-pressure connection 311 is provided on the cooling device, as shown in FIG. 4. A nitrogen-filled gas pressure vessel, for example a conventional gas cylinder with a gas pressure of approx. 200 bar, can be connected to said high-pressure connection. For this purpose, a pressure-relief device 312 and a closing valve 313 are located at the high-pressure connection 311 outside the refrigerator. In the exemplary embodiment, the pressure-relief device 312 is designed and adjusted in such a manner that it reduces the gas, which is under pressure, at the input to an initial pressure of only 50 mbar at which the gas is introduced on the intake side of the pump via the air supply line 516 into the intake line 511.

With a pressure-relief device (also referred to as pressure-reducing valve), the initial pressure is recycled to a control input and, via a pressure transducer, ensures that the pressure valve blocks when the predetermined desired initial pressure is exceeded and opens again when the pressure falls short of the latter. The initial pressure therefore cannot rise above said preset value. A piston or a membrane can be used here as the pressure transducer.

In addition, there are also two hydraulic connections 521 and 522 on the rear wall 33 of the pump module 30. The air supply line 516 and the nonreturn valve 519 can be flushed via the connection 521 which is connected via a valve block 17 to the cold water connection 16b of the cooling device 10.

The rearward connection 522 is connected through inside the pump module 30 to the front-side connection 35. Outside the pump module 30, a line leads to the multiple connection 320 via which the cleaning agent feed lines 61 coming from the cleaning device 60 are connected.

As explained, in order to carry out a cleaning operation, the intake hose 34′ coming from the front-side connection 34 is connected to the second connection 35 and thus forms a loop (dashed line in FIG. 4). A cleaning agent solution 30 is provided by the cleaning device 60. The inlet-side valve 513 is opened and the pump 51 switched on. The cleaning agent solution coming from the cleaning device 60 is therefore sucked up via the intake line 34′, which is connected to form a loop, and is conveyed via the outlet line 514 or the beverage line 16a connected thereto in the direction of the external fully automatic coffee machine. The cleaning agent solution is either collected there at a collecting container placed below the beverage outlet there, or a drainage valve is opened and the cleaning agent solution is diverted upstream of the beverage outlet in the direction of a drain. When the cleaning has ended, the cleaning device switches over to rinsing and provides fresh water for a certain period of time for rinsing the lines.

During operation, the intake line of each of the pump modules 30a, 30a′, 30a″, 30a′″ is connected, as shown in FIG. 4, to an associated storage container 13, 13′, 13″, 13′″. Via the control interface of the cooling device 10, the pump modules 30a, 30a′, 30a″, 30a′″ of a connected beverage-dispensing device, for example a fully automatic coffee machine, can be activated such that a cooled beverage is dispensed. For this purpose, the relevant inlet valve 513 is opened and the pump 51 set into operation. If the air valve 517 is actuated at the same time and the closing valve 313 at the gas connection 511 opened, gas is sucked up by the pump 51. The supplied quantity of gas can be metered via the air valve 517. The pump 51 therefore sucks up a liquid/gas mixture. The counterpressure element 53 at the pump output brings about an increase in pressure inside the pump 51. This results in thorough mixing of the liquid/gas mixture in the pump 51 and in this way produces a deliciously creamy and frothy gas-enriched fluid which is conveyed via the dispensing line 16a in the direction of the connected beverage-dispensing device where it can be dispensed at a corresponding beverage outlet or added to a coffee beverage or to some other beverage.

FIG. 5B illustrates the pump module 30 of the type having two product connections 34, 34a. The design corresponds to that shown in FIG. 5A, with the difference that each of the two product connections 34, 34a is provided with a valve 511, 511a. Downstream of the valves 511, 511a, the lines are connected to the common pump feed line 513 via a T-piece. It is ensured by the controller that, during a product-dispensing operation, only in each case one of the valves 511, 511a is opened. In the event that one of the connected storage containers is empty, a switch can be made to the other product input.

In addition, as already explained, two cleaning connections 35, 35a are provided. The latter are connected in parallel inside the device via a T-piece and are connected through to the rear-side connection 522. In this event of a cleaning operation, the two intake hoses 34′, 34a′ are removed from their respective storage container and connected to in each case one of the two cleaning connections 35, 35a. The cleaning then proceeds in the previously described manner, with the two valves 511, 511a being able to be opened successively in order to flush the intake hoses 34′, 34a′.

In particular milk and cold brew coffee are provided as the liquid foodstuffs which can be stored in the cooling device 10. Milk from a first storage container can be dispensed as milk or milk froth. Cold brew coffee can be dispensed, enriched with gas, as what is referred to as nitro cold brew coffee.

It is essential within the context of the invention in particular that a pump module is provided only for one type of foodstuff. For this purpose, each pump module has a code, for example an RFID chip or a barcode, which can be read via a corresponding reader on the rack frame 20. Via the control interface, the corresponding information is announced to the connected beverage-dispensing device, and therefore the information is present as to which types of liquid foodstuffs are available. If different foodstuff types were to be conveyed with one and the same pump module, this would lead to adverse effects on taste. Via different forms of connection to the intake lines 34′ of the pump modules 30, 30a, it can be ensured that a wrong storage container which is not provided for the relevant pump module is not inadvertently connected. An RFID chip installed in the pump module has the additional advantage that information about the use times, such as for example time in operation, number of dispensing operations of product, number of cleaning cycles, etc. can be programmed on the RFID and can then be retrieved for maintenance purposes.

By releasing the latches 26, each one of the pump modules can be pulled out forward from the rack frame 20. When a pump module is inserted into one of the insertion compartments of the rack frame 20, the electrical and hydraulic plug-in connections 37, 36, 520, 521, 522 present on the rear side of the pump modules are automatically brought together with their corresponding counterparts provided at a corresponding position on the rear side of the rack frame 20 or of the associated insertion compartment and each form an electrical or hydraulic connection to the lines placed inside the cooling device. Simple installation or exchange of a pump module is thus possible.

FIG. 6 illustrates the cleaning device 60 in enlarged form. It comprises a mixing container 62 in which cleaning agent solution is mixed. For this purpose, cleaner concentrate is conveyed out of a cleaning agent container 63 into the mixing container 62. For this purpose, use is made of a metering pump 64, which is connected to the cleaning agent container 63, and a flow meter 65 with which the conveyed quantity of concentrate can be measured and metered. In addition, the flow meter 65 can be used as an empty signalling sensor for the cleaning concentrate.

Located downstream of the flow meter 65 is a switchover valve 66 which, for filling cleaner concentrate into the mixing container 62, is brought into the lower switching position, not shown in FIG. 6. Subsequently, the switchover valve 66 is brought into its upper switching position, shown in FIG. 6. In this switching position, warm water from the warm water connection 68 can be filled into the mixing container 62 via the valve 69, which is open for this purpose. The flow meter 65 can be used in turn to measure and meter the quantity of warm water admitted, and therefore a cleaning agent solution (detergent solution) of a predefined concentration can be mixed in the mixing container 62. A nonreturn valve 67 between metering pump 64 and flow meter 65 prevents water from being able to flow in the direction of the cleaning agent container 63 when the valve 69 is open.

After the cleaning agent solution has been mixed in the mixing container 62, the cleaning device 60 is ready for operation and can provide the cleaning agent solution to the cleaning agent lines 61. The cleaning agent solution is removed from the mixing container 62 via a removal line 70 and a second flow meter 71. The cleaning agent lines 61 leading to the cooling device 10 are each connected via a valve 72a to 72d to the second flow meter 71. The valves 72a to 72d are combined here to form a valve block 72. In order to carry out a cleaning pass through one of the pump modules 30a, 30a′, 30a″, 30a′″, the relevant valve 72a to 72d is opened, and therefore cleaning agent solution can be sucked up by means of the pump 51 of the pump module via the cleaning agent line 61. Subsequently, rinsing is carried out once again with warm water from the warm water connection 68 by the valve 69 being opened and the switchover valve 66 being brought into its upper switching position.

1. A cooling device, comprising:
a coolable storage chamber (15) for storing a plurality of storage containers (11, 12, 13, 14) having liquid foodstuffs,
pump modules, and
two or more receiving compartments (21, 22, 23, 24) that each receive one of the pump modules (30, 30′, 30a, 30a′, 30a″, 30a′″) that are configured for conveying liquid foodstuff of a foodstuff type, which is respectively assigned to the relevant pump module (30, 30′, 30a, 30a′, 30a″, 30a′″), to a beverage-dispensing device connected to the cooling device (10).

2. The cooling device as claimed in claim 1, wherein the receiving compartments (21, 22, 23, 24) each have, on a front side, an opening configured for insertion of one of the pump modules (30, 30′, 30a, 30a′, 30a″, 30a′″) and, on a side facing away from the opening, one or more hydraulic and/or electrical plug-in connections (36, 37) via which, in each case with counterparts arranged and correspondingly positioned on a rear side (33) of an inserted one of the pump modules (30, 30′, 30a, 30a′, 30a″, 30a′″), at least one of a hydraulic or electrical connection of the inserted pump module (30, 30′, 30a, 30a′, 30a″, 30a′″) to the cooling device (10) is adapted to be formed.

3. The cooling device as claimed in claim 1, further comprising a rack frame (20) having insertion compartments (21, 22, 23, 24) configured for receiving the pump modules (30, 30′, 30a, 30a′, 30a″, 30a′″) arranged inside the coolable storage chamber (15), and the pump modules (30, 30′, 30a, 30a′, 30a″, 30a′″) are configured as insertion modules.

4. The cooling device as claimed in claim 1, wherein a front side of each of the pump modules (30, 30′, 30a, 30a′, 30a″, 30a′″) has in each case at least one connection (35), which serves as a product connection, for a flexible intake line (34′) which is connectable to an associated storage container (11, 12, 13, 14, 13′, 13″, 13′″).

5. The cooling device as claimed in claim 4, wherein the front side of each of the pump modules (30, 30′, 30a, 30a′, 30a″, 30a′″) has in each case at least one second connection (35) which is configured as a cleaning connection and with which a flexible intake line (34′) belonging to the respective pump module (30, 30′, 30a, 30a′, 30a″, 30a′″) is connectable, rather than to a storage container (11, 12, 13, 14, 13′, 13″, 13′″), in order to form a loop, wherein the second connection (35) is guided to a rear side (33) of the pump module (30, 30′, 30a, 30a′, 30a″, 30a′″) and is connected there to a cleaning liquid feed line (61).

6. The cooling device as claimed in claim 5, wherein the front side of at least one of the pump modules (30, 30′) has two product closures (34, 34a) for intake lines (34′), which are connectable to separate storage containers (11, 12, 13, 14, 13′, 13″, 13′″), and two cleaning connections, the cleaning connections are connected in parallel inside the pump module (30, 40) and the two product connections (34) are selectively connectable to a pump (51) of the pump module (30, 40) via a valve arrangement (511).

7. The cooling device as claimed in claim 1, wherein a rear side of each of the pump modules (30, 30′, 30a, 30a′, 30a″, 30a′″) has at least one hydraulic plug-in connection (36) which, in each case with a counterpart arranged and correspondingly positioned on a rear side of the receiving compartments (21, 22, 23, 24), forms a hydraulic connection to in each case one beverage line (16a) placed inside the cooling device (10) for the respective liquid foodstuff to be conveyed.

8. The cooling device as claimed in claim 1, wherein each of the pump modules (30, 30a, 30a′, 30a″, 30a′″) has a code which is readable via the cooling device (10) and which specifies the foodstuff type assigned to the pump module (30, 30a, 30a′, 30a″, 30a′″), and the cooling device (10) is configured to announce the foodstuff type read by the respective pump module (30, 30a, 30a′, 30a″, 30a′″) to a connected beverage-dispensing device.

9. The cooling device as claimed in claim 1, wherein at least one of the pump modules (30, 30′, 30a, 30a′, 30a″, 30a′″) has a pump (51), a gas supply line (516, 516′) opening on a suction side of the pump (51) into a pump feed line (513), and a counterpressure element (53) which is arranged downstream of the pump (51) in a conveying direction and via which fluid sucked up by the pump (51) is adapted to be conveyed in a direction of the beverage-dispensing device connected to the cooling device (10).

10. The cooling device as claimed in claim 9, further comprising at least one of a restrictor or a static mixer that is used as the counterpressure element (53).

11. The cooling device as claimed in claim 10, wherein a gas-metering valve (517) is arranged in the gas supply line (516, 516′) for metering gas supplied to the liquid foodstuff.

12. The cooling device as claimed in claim 11, further comprising a high-pressure connection (311) for connecting a gas pressure vessel which is arranged outside the cooling device and in which gas is stored under pressure, a pressure-relief device (312) which is connected on an input side to the high-pressure connection (311) and which is designed to reduce a pressure of the gas to a pressure close to ambient pressure, and which is connected on an output side to the gas supply line (516, 516′) which opens into the pump feed line (513) in order to supply the gas at a reduced pressure to the sucked-in beverage on the suction side of the pump (51).

13. The cooling device as claimed in claim 1, further comprising a control interface circuit (37) configured to be connected to a controller which is assigned to the external beverage-dispensing device and via which the pump modules (30, 30′, 30a, 30a′, 30a″, 30a′″) configured to be activated.

14. An arrangement comprising the cooling device as claimed in claim 1 and a cleaning device (60) which is connected to the cooling device (10) and which supplies the individual pump modules (30, 30′, 30a, 30a′, 30a″, 30a′″) of the cooling device (10) with cleaning liquid via separate cleaning liquid feed lines (61), which are connected to a connection array (320) of the cooling device (10), for carrying out cleaning operations.

15. The arrangement as claimed in claim 14, wherein the cleaning device (60) has a cleaning agent storage container (63) for cleaner concentrate, a mixing container (62) configured for mixing a cleaning liquid consisting of cleaner concentrate and water, a water inlet (68) which is connectable to the mixing container (62) via a shut-off valve (66, 69), a metering pump (64) for metered conveying of cleaner concentrate from the cleaning agent storage container (63) into the mixing container (62), and a plurality of outlet connections which are connected to the mixing container (62) and can be activated separately via separate outlet valves (72a, 72b, 72c, 72d) and which are connected to the cleaning liquid feed lines (61) of the cooling device (10).

16. The cooling device as claimed in claim 5, wherein the cleaning liquid feed line (61) is guided via a hydraulic plug-in connection, which is located on a rear side (33) of the respective pump module (30, 30′, 30a, 30a′, 30a″, 30a′″), to a cleaning device (60) which is connected to the cooling device (10) and which supplies the respective pump module (30, 30′, 30a, 30a′, 30a″, 30a′″) with cleaning liquid in order to carry out a cleaning operation.

17. The cooling device as claimed in claim 8, wherein the cooling device (10) is configured to additionally announce a current operating state of the pump modules (30, 30a, 30a′, 30a″, 30a′″).

18. The cooling device as claimed in claim 10, wherein the pump comprises a geared pump.
